(19) United States
(12) Patent Application Publication
(10) Pub. No.: US 2013/0016188 A1
(43) Pub. Date: Jan. 17, 2013

(54) CAMERA MODULE AND IMAGE CAPTURING METHOD

(71) Applicant: Takayuki OGASAHARA, Kanagawa (JP)

(72) Inventor: Takayuki OGASAHARA, Kanagawa (JP)

(73) Assignee: Kabushiki Kaisha Toshiba, Tokyo (JP)

(21) Appl. No.: 13/419,755

(22) Filed: Mar. 14, 2012

(30) Foreign Application Priority Data
Jul. 15, 2011 (JP) 2011-156758

(51) Int. Cl. H04N 13/02; H04N 5/238

(52) U.S. Cl. 348/49; 348/364; 348/E13.074; 348/E05.04

(57) ABSTRACT

According to the embodiment, a camera module has a variable aperture unit and a control driver. In the variable aperture unit, switching is made between transmitting and blocking of the light incident from the imaging lens for each region. In the variable aperture unit, at least one of an area and a position of the transmissive region for transmitting light can be changed. The control driver can adjust the imaging timing of the image sensor in response to at least one of the area and the position of the transmissive region.

### CROSS-REFERENCE TO RELATED APPLICATIONS

This application is based upon and claims the benefit of priority from Japanese Patent Application No. 2011-156758, filed on Jul. 15, 2011; the entire contents of which are incorporated herein by reference.

### FIELD

The present embodiment typically relate to a camera module and an image capturing method.

### BACKGROUND

Recently, there has been widely used a camera module that obtains a 3-dimensional stereoscopic image by capturing a left-eye image and a right-eye image having disparity with each other in parallel. Further, in the related art, a technique has been proposed, in which a high dynamic range (HDR) operation is implemented by synthesizing the object image obtained by capturing images with different exposures. In order to obtain both the left-eye image and the right-eye image, for example, two imaging optical systems are used in the 3-dimensional image capturing. In addition, the exposure is adjusted by controlling the aperture, for example, which uses a mechanical mechanism. If configurations necessary in each function are just combined to implement such functions in the image capturing using a single camera module, the structure of the camera module may be complicated or large-sized, which is problematic.

### BRIEF DESCRIPTION OF THE DRAWINGS

FIG. 1 is a block diagram illustrating the schematic configuration of a camera module according to an embodiment;

FIG. 2 is a diagram illustrating light propagation from an imaging lens to an image sensor;

FIG. 3 is a plan view illustrating the imaging lens side of a variable aperture unit;

FIG. 4 is a block diagram illustrating a configuration for performing a 3D image capturing function;

FIG. 5 is a diagram illustrating driving of the variable aperture unit in the 3D image capturing;

FIG. 6 is a flowchart illustrating a procedure of the 3D image capturing;

FIG. 7 is a block diagram illustrating a configuration for performing an HDR image capturing function;

FIG. 8 is a diagram illustrating driving of the variable aperture unit in the HDR image capturing;

FIG. 9 is a flowchart illustrating a procedure of the HDR image capturing;

FIG. 10 is a block diagram illustrating a configuration for performing a simultaneous multi-view image capturing function;

FIG. 11 is a diagram illustrating driving of the variable aperture unit in the simultaneous multi-view image capturing; and

FIG. 12 is a flowchart illustrating a procedure of the simultaneous multi-view image capturing.

### DETAILED DESCRIPTION

According to an embodiment, the camera module includes an imaging lens, an image sensor, a variable aperture unit, a signal processing unit, and a control driver. The imaging lens receives light from an object and forms an object image. The image sensor images the object image. The variable aperture unit is arranged in the middle of the optical path between the imaging lens and the image sensor. The variable aperture unit can adjust the amount of light passing to the image sensor side by switching between transmitting and blocking of the light incident from the imaging lens in each region. The signal processing unit processes the image signal obtained through the imaging of the image sensor. The control driver controls driving of the image sensor and the variable aperture unit. The variable aperture unit can change at least one of an area and a position of the transmissive region where light is transmitted. The control driver can adjust the imaging timing for the image sensor in response to at least one of the area and the position of the transmissive region.

A camera module and an image capturing method according to an embodiment will be explained in detail below with reference to the accompanying drawings. The present invention is not limited to the embodiment.

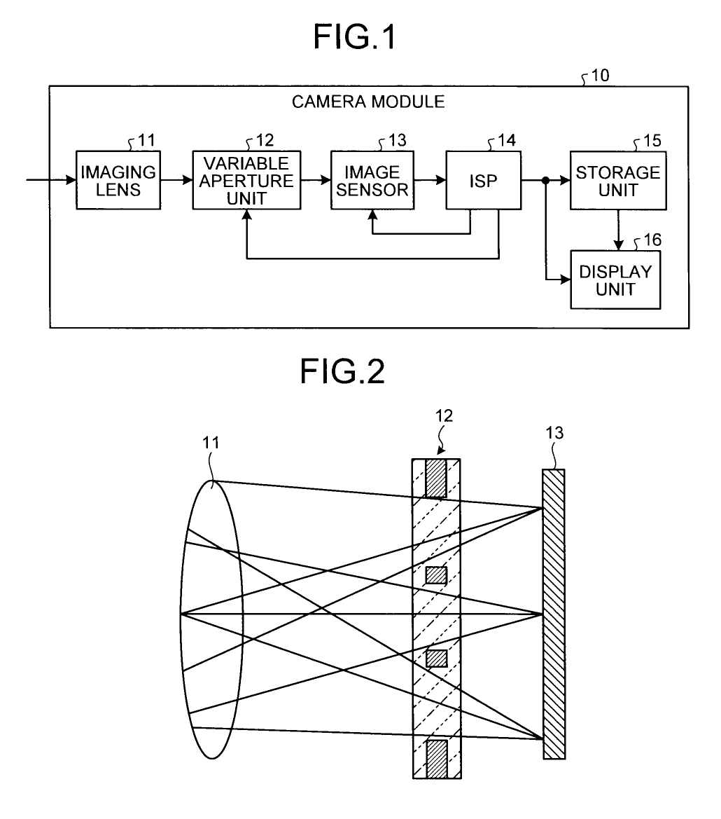

FIG. 1 is a block diagram illustrating a schematic configuration of the camera module according to an embodiment. The camera module 10 is, for example, a digital camera. The camera module 10 may be an electronic apparatus other than the digital camera, such as a camera-imbedded mobile terminal.

The camera module 10 includes an imaging lens 11, a variable aperture unit 12, an image sensor 13, an image signal processor (ISP) 14, a storage unit 15, and a display unit 16.

The imaging lens 11 receives light from an object and forms an object image in the image sensor 13. The image sensor 13 images the object image. The variable aperture unit 12 is arranged in the middle of the optical path between the imaging lens 11 and the image sensor 13. The variable aperture unit 12 can adjust the amount of light passing to the image sensor 13 side by switching between transmitting and blocking of the light incident from the imaging lens 11 in each region.

The ISP 14 processes the image signal obtained through imaging of the image sensor 13. The ISP 14 performs, for example, shading correction, automatic exposure (AE) adjustment, automatic white balance (AWB) adjustment, matrix processing, contour enhancement, luminance compression, gamma processing on a raw image output from the image sensor 13.

The storage unit 15 stores an image subjected to the image processing in the ISP 14. The storage unit 15 outputs an image signal to the display unit 16 in response to manipulation of a user and the like. The display unit 16 displays an image in response to the image signal input from the ISP 14 or the storage unit 15. The display unit 16 is, for example, a liquid crystal display.

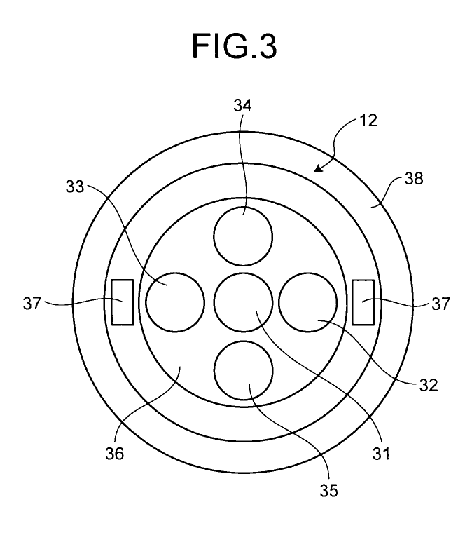

FIG. 2 is a diagram illustrating propagation of the light from the imaging lens to the image sensor. FIG. 3 is a plan view illustrating the imaging lens side of the variable aperture unit. The variable aperture unit 12 includes regions 31 to 36 that can switch between transmitting and blocking of light. In addition, the variable aperture unit 12 has an electrode 37 for connection to a power supply (not shown).

Each region 31 to 36 includes, for example, an electrochromic element. The electrochromic element changes the transmittance of light using electrochemical oxidation/reduction responses. For example, each region 31 to 36 may be configured to use a liquid crystal element. The liquid crystal element changes its liquid crystal alignment according to a voltage so as to change the transmittance of light. The variable aperture unit 12 can adjust the amount of light passing to the image sensor 13 side by switching between transmitting and blocking of light in each region 31 to 36 in response to the applied voltage.

The region 36 has a circular outer periphery. Five regions 31 to 35 are formed in the inner side of the circle of the outer periphery of the region 36. The region 36 is a part excluding the five regions 31 to 35 in the circle. The region 31 is located in the center of the variable aperture unit 12. Four regions 32 to 35 are arranged around the region 31. A lens barrel 38 has a cylindrical shape. The lens barrel 38 supports the imaging lens 11 and the variable aperture unit 12.

Next, each function of the camera module according to an embodiment will be described. It is assumed that the camera module 10 has functions of, for example, 3-dimensional image capturing, HDR image capturing, and simultaneous multi-view image capturing, and the camera module 10 can perform at least two of such functions.

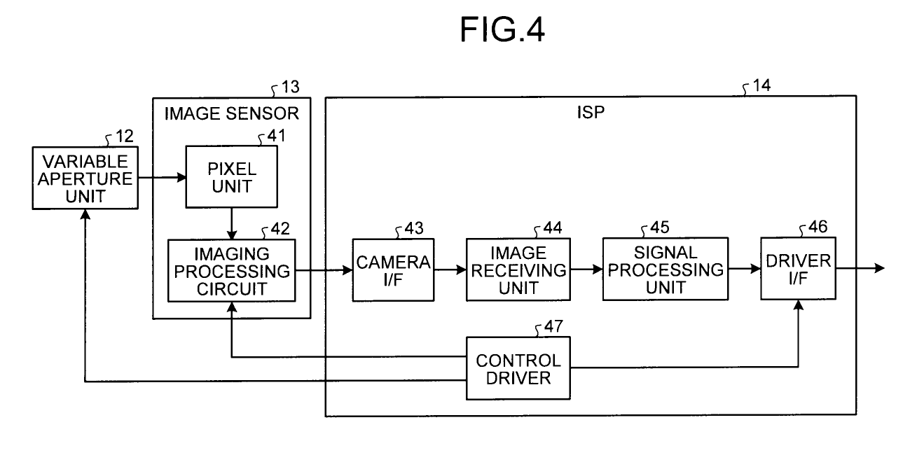

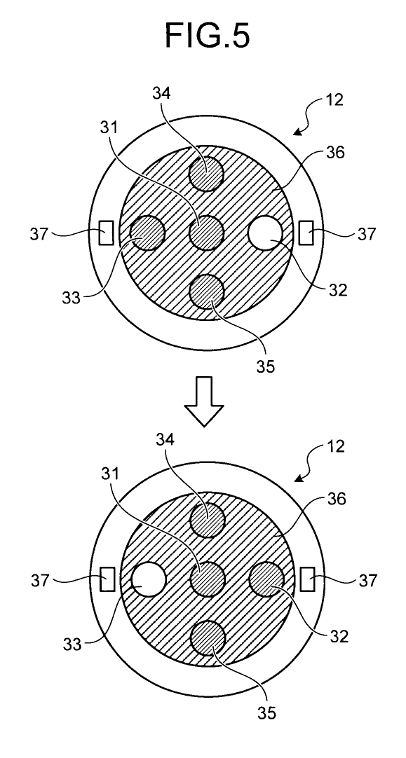

FIG. 4 is a block diagram illustrating a configuration for performing the 3-dimensional image capturing function. The image sensor 13 has a pixel unit 41 and an imaging processing circuit 42. The pixel unit 41 outputs an image signal generated by the photoelectric conversion in each pixel. The imaging processing circuit 42 drives the pixel unit 41 and also processes the image signal from the pixel unit 41.

The ISP 14 includes a camera interface (I/F) 43, an image receiving unit 44, a signal processing unit 45, a driver interface (I/F) 46, and a control driver 47. The raw image obtained by the imaging in the image sensor 13 is received from the camera I/F 43 by the image receiving unit 44.

The signal processing unit 45 processes the signal of the raw image received by the image receiving unit 44. The driver I/F 46 outputs an image signal subjected to the signal processing in the signal processing unit 45 to the storage unit 15 and the display unit 16 (see FIG. 1). The control driver 47 controls the variable aperture unit 12, the imaging processing circuit 42, and the driver I/F 46. In addition, the control driver 47 generates a frame timing applied to the image sensor 13.

FIG. 5 is a diagram illustrating driving of the variable aperture unit in the 3-dimensional image capturing. In the drawing, it is assumed that the hatched portions of the regions 31 to 36 represent a light blocking state, and the blank portion represents a light transmitting state.

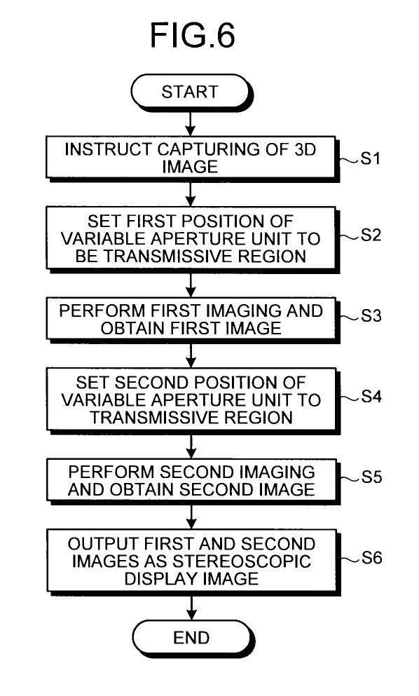

FIG. 6 is a flowchart illustrating a procedure of capturing the 3D image. The control driver 47 changes a position of the transmissive region for transmitting light therethrough out of the variable aperture unit 12 in capturing the 3D image. Herein, the position of the region 32 positioned on the right side of the center region 31 of the variable aperture unit 12 is referred to as a first position. The position of the region 33 positioned on the left side of the center region 31 of the variable aperture unit 12 is referred to as a second position which is shifted from the first position in a horizontal direction.

When the camera module 10 is instructed to capture the 3D image (Step S1), the control driver 47, as a first step, sets the region 32 which is the first position in the variable aperture unit 12 to the transmissive region (Step S2). As illustrated in the upper side of FIG. 5, the control driver 47 sets the region 32 to be in a light transmitting state, and the other regions 31 and 33 to 36 to be in a light blocking state.

The image sensor 13 performs first imaging with the region 32 set to the transmissive region. The image sensor 13 obtains a first image, for example, the right-eye image through the first imaging (Step S3).

Next, the control driver 47, as a second step, sets the region 33 which is the second position in the variable aperture unit 12 to the transmissive region (Step S4). As illustrated in the lower side of FIG. 5, the control driver 47 switches the state of the region 32 which has been set to be in the light transmitting state in the first step to the light blocking state. In addition, the control driver 47 switches the region 33 to the light transmitting state. The control driver 47 causes the regions 31 and 34 to 36 to remain in the light blocking state.

The image sensor 13 performs second imaging with the region 33 set to the transmissive region. The image sensor 13 obtains a second image, for example, the left-eye image through the second imaging (Step S5).

The control driver 47 switches the transmissive region of the variable aperture unit 12 at a constant frame rate of, for example, 60 fps (frame per second). In addition, the control driver 47 controls the imaging processing circuit 42 such that the imaging is performed in synchronization with the switching of the transmissive region in the variable aperture unit 12. In the image sensor 13, the imaging timing is set to be constant between the first imaging and the second imaging.

The signal processing unit 45 outputs the right-eye image of the first image and the left-eye image of the second image as a stereoscopic display image (Step S6). The control driver 47 switches the output to the display unit 16 between the right-eye image and the left-eye image by controlling the driver I/F 46. In this manner, the camera module 10 obtains the 3-dimensional stereoscopic image by sequentially capturing two images captured from different viewpoints in a horizontal direction.

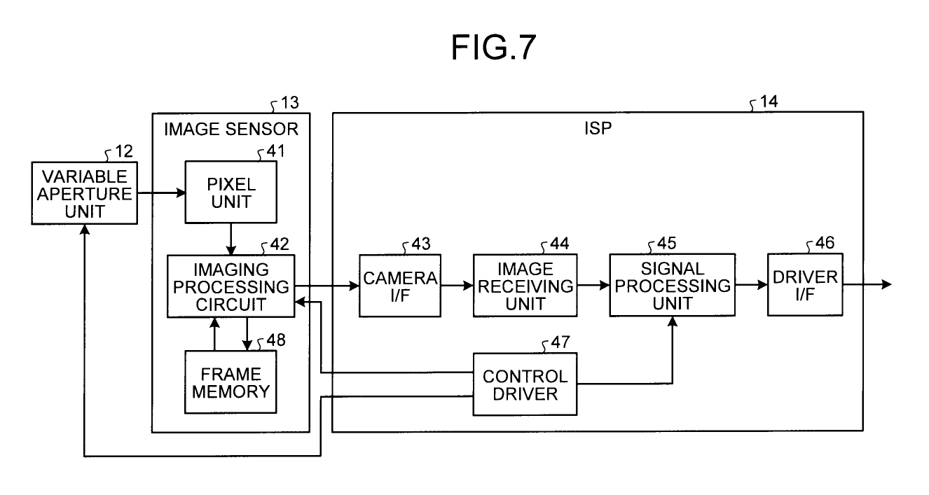

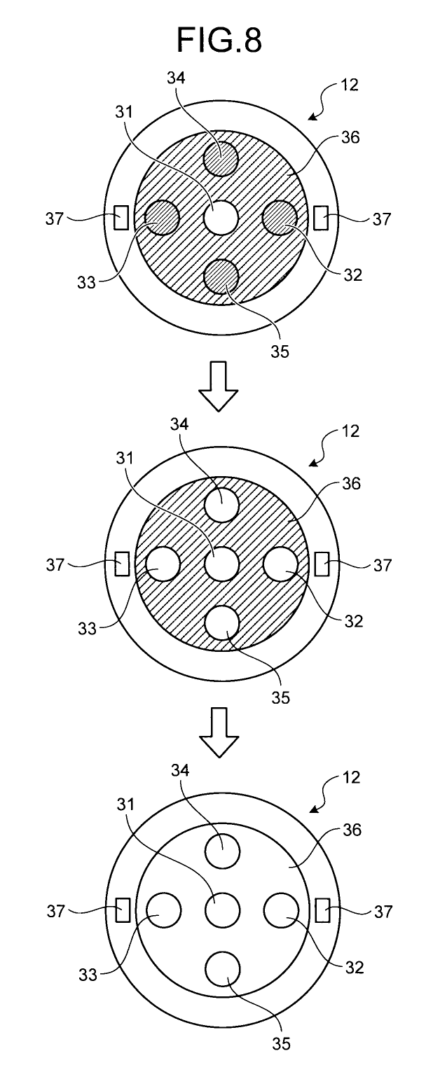

FIG. 7 is a block diagram illustrating a configuration for performing the HDR image capturing function. The image sensor 13 includes a frame memory 48. The frame memory 48 appropriately stores the image signal from the imaging processing circuit 42. The control deriver 47 controls the variable aperture unit 12, the imaging processing circuit 42, and the signal processing unit 45.

FIG. 8 is a diagram illustrating driving of the variable aperture unit in the HDR image capturing. In the drawing, it is assumed that the hatched portions of the regions 31 to 36 represent a light blocking state, and the blank portions represent a light transmitting state.

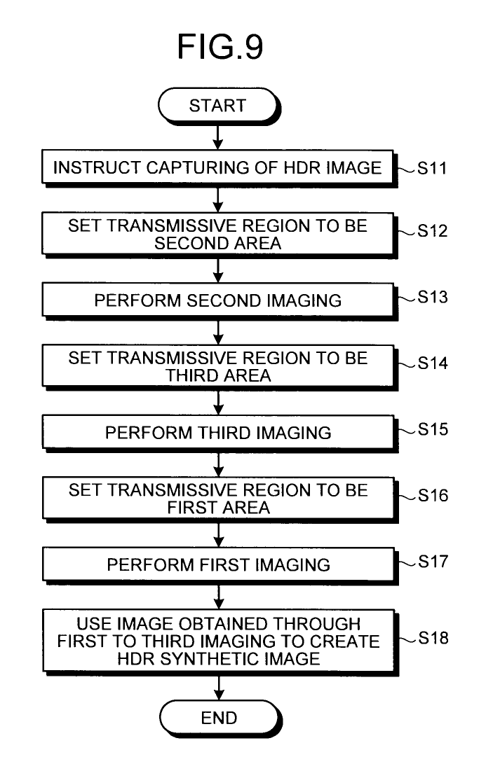

FIG. 9 is a flowchart illustrating a procedure of the HDR image capturing. The control driver 47 changes the area of the transmissive region for transmitting light therethrough out of the variable aperture unit 12 in capturing the HDR image. Herein, the total area of the regions 31 to 36 is set to a first area, the area of the region 31 is set to a second area, and the total area of the regions 31 to 35 is set to a third area. The control driver 47 changes the area of the transmissive region in the order of the second area, the third area, and the first area.

When the camera module 10 is instructed to capture the HDR image (Step S11), the control driver 47, as a first step, sets the transmissive region to a second area (Step s12). The control driver 47, as illustrated in the upper side of FIG. 8, sets the center region 31 to be in the light transmitting state and the other regions 32 to 36 to be in the light blocking state.

The image sensor 13 performs the second imaging with the second area of the region 31 set to the transmissive region (Step S13).

Next, the control driver 47, as a second step, sets the transmissive region to the third area (Step S14). The control driver 47, as illustrated in the middle of FIG. 8, switches the regions 32 to 35 which have been in the light blocking state in the first step to be in the light transmitting state. The control driver 47 causes the region 31 to remain in the light transmitting state. In addition, the control driver 47 causes the region 36 to remain in a light blocking state.

The image sensor 13 performs third imaging with the third area of the regions 31 to 35 set to the transmissive region (Step S15).

Next, the control driver 47, as the third step, sets the transmissive region to be the first area (Step S16). The control driver 47 switches the region 36 having a light blocking state until the second step into a light transmitting state. In addition, the control driver 47 causes the regions 31 to 35 to remain in the light transmitting state.

The image sensor 13 performs the first imaging with the first area of the regions 31 to 36 set to the transmissive region (Step S17).

The variable aperture unit 12 sequentially increases the amount of light passing to the image sensor 13 side by enlarging the area of the transmissive region in the order of the second area, the third area, and the first area. The camera module 10 changes the amount of light incident to the image sensor 13 by changing the area of the transmissive region of the variable aperture unit 12. In addition, the variable aperture unit 12 is not limited to the case where the transmissive region is changed in the order of the second area, the third area, and the first area. How to change the area of the transmissive region may be appropriately changed.

The control driver 47 changes the area of the transmissive region in the variable aperture unit 12 and the frequency (frame rate) at which the image signal is output from the pixel unit 41. The control driver 47 sets the frame rate of the image sensor 13 to, for example, 60 fps in the second imaging when the transmissive region is set to the second area. The control driver 47 sets the frame rate of the image sensor 13 to, for example, 15 fps in the third imaging when the transmissive region is set to the third area. In addition, the control driver 47 sets the frame rate of the image sensor 13 to, for example, 7.5 fps in the first imaging when the transmissive region is set to the first area.

In this manner, the control driver 47 controls the imaging processing circuit 42 such that the imaging timing interval of the image sensor 13 is reduced as the area of the transmissive region of the variable aperture unit 12 increases. The image sensor 13 sequentially images the object image with different exposures by controlling the variable aperture unit 12 and the imaging processing circuit 42.

According to the present embodiment, the image sensor 13 performs imaging in the first, second, and third steps with different exposures. The image sensor 13 temporarily stores the image signal obtained through the imaging in the first and second steps in the frame memory 48 and outputs it along with the image signal obtained through the imaging in the third step. In addition, the image sensor 13 reads the image signal stored in the frame memory 48.

The camera module 10 uses the image obtained through the first imaging to the third imaging to create an HDR synthesized image (Step S18). If the signal processing unit 45 is notified by the control driver 47 that the HDR image capturing is instructed, the signal processing unit 45 synthesizes portions with an appropriate exposure out of each image having different exposures to create an HDR synthesized image.

The signal processing unit 45 interpolates the signal value of the pixel in which the incident light amount, for example, in the imaging of the third step is saturated using the signal value obtained through the imaging of the second or first step. In this manner, the camera module 10 can perform the HDR image capturing by synthesizing the images obtained with different exposures.

In addition, the embodiment is not limited to the case where the camera module 10 changes the exposure by adjusting the frame rate and the transmissive region of the variable aperture unit 12. The camera module 10 may change the exposure, for example, by maintaining a constant frame rate and adjusting the transmissive region of the variable aperture unit 12. In addition, the embodiment is not limited to the case where the camera module 10 obtains the synthesized image from three-step images with different exposures for the HDR image capturing. The synthesized image may be obtained from a plurality of images with different exposures.

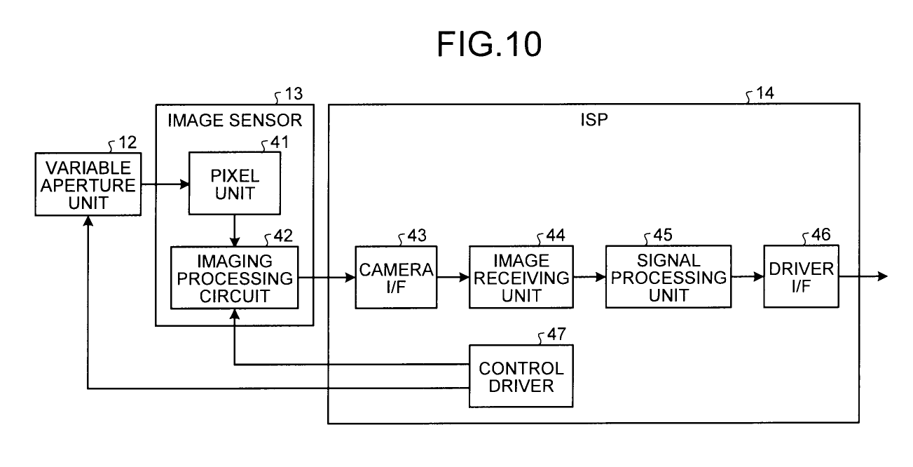

FIG. 10 is a block diagram illustrating a configuration for performing the simultaneous multi-view image capturing function. The control driver 47 controls the variable aperture unit 12 and the imaging processing circuit 42.

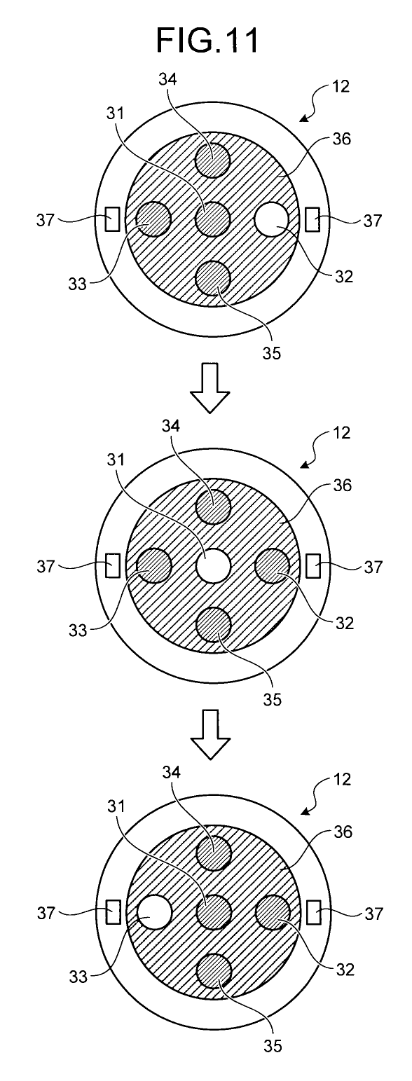

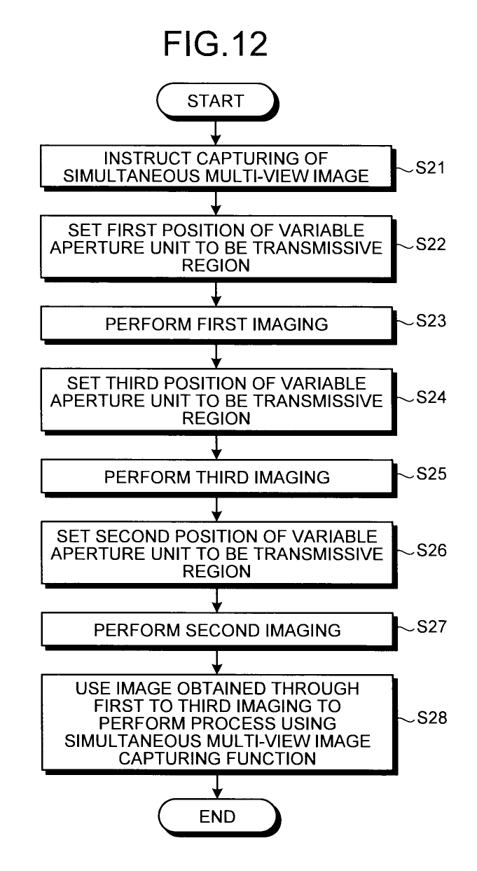

FIG. 11 is a diagram illustrating driving of the variable aperture unit in the simultaneous multi-view image capturing. FIG. 12 is a flowchart illustrating a procedure of the simultaneous multi-view image capturing. The control driver 47 changes a position of the transmissive region for transmitting light out of the variable aperture unit 12 in the simultaneous multi-view image capturing. Herein, the position of the region 32 positioned on the right side of the center region 31 of the variable aperture unit 12 is referred as a first position. The position of the region 33 positioned on the left side of the center region 31 of the variable aperture unit 12 is referred as a second position. The center region 31 of the variable aperture unit 12 is referred to as a third position.

When the camera module 10 is instructed for the simultaneous multi-view image capturing (Step S21), the control driver 47, as a first step, sets the region 32 which is the first position in the variable aperture unit 12 to the transmissive region (Step S22). The control driver 47, as illustrated in the upper side of FIG. 11, sets the region 32 to be in the light transmitting state, and the other regions 31 and 33 to 36 to be in the light blocking state.

The image sensor 13 performs the first imaging with the region 32 set to the transmissive region (Step S23).

Next, the control driver 47, as a second step, sets the region 31 which is the third position in the variable aperture unit 12 to the transmissive region (Step S24). The control driver 47, as illustrated in the middle of FIG. 11, switches the region 32 which has been in the light transmitting state in the first step to the light blocking state. In addition, the control driver 47 switches the region 31 into the light transmitting state. The control driver 47 causes the regions 33 to 36 to remain in the light blocking state.

The image sensor 13 performs the third imaging with the region 31 set to the transmissive region (Step S25).

Next, the control driver 47, as a third step, sets the region 33 which is the second position in the variable aperture unit 12 to the transmissive region (Step S26). The control driver 47, as illustrated in the lower side of FIG. 11, switches the region 31 which has been in the light transmitting state in the second step to the light blocking state. In addition, the control driver 47 switches the region 33 to the light transmitting state. The control driver 47 causes the regions 32 and 34 to 36 to remain in the light blocking state.

In addition, the variable aperture unit 12 may appropriately change the sequence of changing the position of the transmissive region. Furthermore, the embodiment is not limited to the case where the switching between the transmitting and light blocking states is performed for the regions 31, 32, and 33 in the variable aperture unit 12. It is assumed that the variable aperture unit 12 can switch between light transmitting and blocking states in at least two of the regions 31 to 35. As a result, the camera module 10 can perform the simultaneous multi-view image capturing.

In this manner, for the simultaneous multi-view image capturing, the control driver 47 changes the position of the transmissive region for transmitting light out of the variable aperture unit 12. The image sensor 13 captures the object from different viewpoints.

The control driver 47 switches the transmissive region of the variable aperture unit 12 at a constant frame rate of, for example, 60 fps. In addition, the control driver 47 controls the imaging processing circuit 42 such that the imaging is performed in synchronization with the switching of the transmissive region in the variable aperture unit 12.

The camera module 10 uses the images obtained through the first imaging to the third imaging to perform a process using the simultaneous multi-view image capturing function (Step S28). The camera module 10 may estimate distance to an object or perform a reconfiguration processing of a 2-dimensional image by synthesizing images, using a plurality of images captured from different viewpoints. In addition, the camera module 10 may obtain depth information of the object using the images obtained from different viewpoints. The camera module 10 can perform image processing such as refocusing by using such depth information.

In the related art, for example, a binocular configuration is employed to capture an object from a plurality of viewpoints or capture the 3-dimensional image. The camera module 10 according to the present embodiment can use the variable aperture unit 12 for each function of the 3-dimensional image capturing, the HDR image capturing, and the simultaneous multi-view image capturing. Using the variable aperture unit 12, the camera module 10 can perform image capturing based on a plurality of functions with an easier and smaller configuration in comparison with the case where the configurations necessary in each function of the image capturing are simply combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera module comprising:
an imaging lens that receives light from an object and forms an object image;
an image sensor that images the object image;
a variable aperture unit arranged in the middle of an optical path between the imaging lens and the image sensor, the variable aperture unit being able to adjust the amount of light passing to the image sensor by switching between transmitting and blocking of the light incident from the imaging lens in each region;
a signal processing unit that performs signal processing on an image signal obtained through the imaging in the image sensor; and
a control driver that controls driving of the image sensor and the variable aperture unit,
wherein the variable aperture unit can change at least one of an area and a position of a transmissive region where light is transmitted, and
the control driver can adjust an imaging timing of the image sensor in response to at least one of the area or the position of the transmissive region.

2. The camera module according to claim 1, wherein the control driver changes the area of the transmissive region into a first area and a second area smaller than the first area, and
the signal processing unit obtains a synthesized image by interpolating a signal value of a pixel for which an output for an incident light amount is saturated in second imaging in which the transmissive region is set to the second area using a signal value obtained in first imaging in which the transmissive region is set to the first area.

3. The camera module according to claim 2, wherein the control driver changes the area of the transmissive region and a frequency at which the image signal is output from the image sensor.

4. The camera module according to claim 3, wherein the control driver controls driving of the image sensor and the variable aperture unit such that the imaging timing is reduced as the area of the transmissive region increases.

5. The camera module according to claim 1, wherein the control driver changes the transmissive region into a plurality of positions and maintains a constant imaging timing of the image sensor in the imaging in which the transmissive region is set in different positions.

6. The camera module according to claim 5, wherein the control driver changes the transmissive region into a first position and a second position shifted from the first position in a horizontal direction, and
the signal processing unit outputs, as a stereoscopic display image, a first image obtained through first imaging in which the transmissive region is set to the first position and a second image obtained through second imaging in which the transmissive region is set to the second position.

7. The camera module according to claim 1, wherein the variable aperture unit includes an electrochromic element.

8. An image capturing method comprising:
imaging an object image by receiving light from an object and forming an image;
adjusting a light amount used in the imaging of the object image by switching between transmitting and blocking of the light from the object in each region;
performing signal processing on the image signal obtained through imaging of the object image; and
controlling an imaging timing of the object image and the switching between transmitting and blocking of the light in each region,
wherein at least one of an area and a position of the transmissive region where light is transmitted out of the regions can be changed; and
the imaging timing can be adjusted in response to at least one of the area and the position of the transmissive region.

9. The image capturing method according to claim 8, wherein the area of the transmissive region is changed into a first area and a second area smaller than the first area, and
a synthesized image is obtained by interpolating a signal value of a pixel where an output for the incident light amount is saturated in second imaging in which the transmissive region is set to the second area using a signal value obtained in first imaging in which the transmissive region is set to the first area.

10. The image capturing method according to claim 9, wherein the area of the transmissive region and a frequency at which the image signal obtained by imaging the object image is output are changed.

11. The image capturing method according to claim 10, wherein the imaging timing and the switching between transmitting and blocking of the light in each region are controlled such that the imaging timing is reduced as the area of the transmissive region increases.

12. The image capturing method according to claim 8, wherein the transmissive region is changed in a plurality of positions, and the imaging timing is maintained to be constant in imaging in which the transmissive region is set in different positions.

13. The image capturing method according to claim 12, wherein the transmissive region is changed into a first position and a second position shifted from the first position in a horizontal direction, and
a first image obtained through the first imaging in which the transmissive region is set to the first position and a second image obtained through the second imaging in which the transmissive region is set to the second position are output as a stereoscopic display image.

14. The image capturing method according to claim 12, wherein a plurality of images is obtained through image capturing from different viewpoints by imaging the object image whenever the position of the transmissive region is changed.

15. The image capturing method according to claim 8, wherein switching can be made between
an operation of changing the area of the transmissive region between a first area and a second area smaller than the first area and obtaining a synthesized image by interpolating a signal value of a pixel where an output for the incident light amount is saturated when the transmissive region is set to the second area using a signal value obtained by setting the transmissive region to the first area, and
an operation of changing the position of the transmissive region between a first position and a second position and obtaining a first image through imaging when the transmissive region is set to the first position and a second image through imaging when the transmissive region is set to the second position.
